(19) United States
(12) Patent Application Publication
(10) Pub. No.: US 2009/0053678 A1
(43) Pub. Date: Feb. 26, 2009

(54) Method for Reading and Writing Data Wirelessly from Simulated Munitions

(76) Inventors: Robert August Falkenhayn, Buford, GA (US); Henry Martin Wilson, JR., Buford, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/167,684

(22) Filed: Jul. 3, 2008

Related U.S. Application Data
(60) Provisional application No. 60/948,183, filed on Jul. 5, 2007.
(60) Provisional application No. 60/968,041, filed on Aug. 24, 2007.

(51) Int. Cl. F41A 33/00; H04Q 5/22

(52) U.S. Cl. 434/16; 340/10.4

(57) ABSTRACT

A weapon simulation system includes a simulated weapon and simulated munition, with the simulated weapon being in electrical communication with a primary simulation computer and an instructor computing station. The simulated munition includes an RFID tag installed therein, with the RFID tag having information about the particular simulated munition. When the simulated munition is placed in an insert in the simulated weapon, an RFID transceiver in the simulated weapon will read the information from the RFID tag using an antenna, and further transmit the identification information of the simulated munition to a weapon controller. The weapon controller is further in electrical communication with a primary simulation computer generating a simulation, which is in electrical communication with an instructor computer.

### CROSS REFERENCE TO RELATED PATENT APPLICATIONS

This application claims the benefit of priority of U.S. provisional patent application Ser. No. 60/948,183, filed on Jul. 5, 2007, and U.S. provisional patent application Ser. No. 60/968,041, filed Aug. 24, 2007, each said application being relied upon and incorporated herein by reference.

### BACKGROUND OF THE INVENTION

Weapon simulation systems are commonly used for combat training and/or shooting practice. Such systems are designed to simulate the effects of a specific weapon type with a specific computer-generated target. There are numerous different types of munitions that are compatible with any one weapon, such as a 40 mm grenade launcher (manufacturer independent). Some of these round types include high explosive, airburst, star cluster, flare, smoke, and practice. Because of this, there have been many attempts by firearms simulation manufacturers to create a method for simulating different types of munitions to be used in weapon simulation systems and be able to monitor the type of munition used in the weapon simulation system.

One method for reading different round types on a mortar launcher was using different color charge rings and a compatible color sensor to detect which charge ring is installed on the mortar. The mortar would then communicate via contacts on the mortar and launcher once the mortar had come to rest. This system was limited in many ways. The largest problem was sunlight causing large offsets and incorrect readings with the color sensor. Another issue is the ability to pick up a difference in color. Because the colors had to have a significant difference in wavelength in order to detect each one with no errors, the round types were limited to less than ten. Additionally, communicating via electrical contacts proved to be unreliable due to corrosion and mechanical bounce. Lastly, there was no ability to store any other data on the round such as a serial number or usage data. Other methods for determining different round types suffer from very similar limitations.

Another example of a previous method for detecting round type is described in U.S. Pat. No. 5,201,658. This implementation uses frequency resonance to detect different round types. There are a few disadvantages to using this type of detection. The most notable disadvantage is the inability to convey more information than just the round type. Additionally the round frequency is set by hardware design and cannot be changed without disassembling the round and replacing the resonant circuit.

### SUMMARY OF THE INVENTION

A system and method for reading and writing data wirelessly from simulated munitions during a weapon simulation scenario includes a simulated weapon that is in electrical connection with a primary simulation computer and an instructor computing station. The simulated weapon includes an insert which will receive a simulated munition. The insert includes an antenna that is connected to an RFID transceiver, with the transceiver further being connected to a weapon controller. An RFID tag is installed within the simulated munition, with the RFID tag storing information about the simulated munition and transmitting that information to the weapon controller via the RFID transceiver when the simulated munition passes the antenna. The weapon controller will further transmit the simulated munition information to the primary simulation computer for proper identification in the weapon simulation.

### BRIEF DESCRIPTION OF THE DRAWINGS

FIG. 1 is a block diagram of the components of a weapon simulation system incorporating a simulated munition having wireless transmissions with a controller of a simulated weapon;

FIG. 2a is a side sectional exploded view of one embodiment of the simulated munition used in the simulated weapon;

FIG. 2b is a side sectional view of the assembled simulated munition illustrated in FIG. 2a;

FIG. 3a is a perspective view of a first embodiment of an insert;

FIG. 3b is a perspective view of a second embodiment of the insert;

FIG. 4 is a composite side sectional view of the simulated munition illustrated in FIG. 2b combined with the insert illustrated in FIG. 3 in a simulated weapon;

FIG. 5 is a composite side sectional view of the simulated munition combined with the insert as illustrated in FIG. 4, the antenna having an extended wrap around the insert; and

FIG. 6 is an exploded side sectional view of the simulated munition with respect to the insert, the antenna extending around the edge of the insert.

### DESCRIPTION OF THE INVENTION

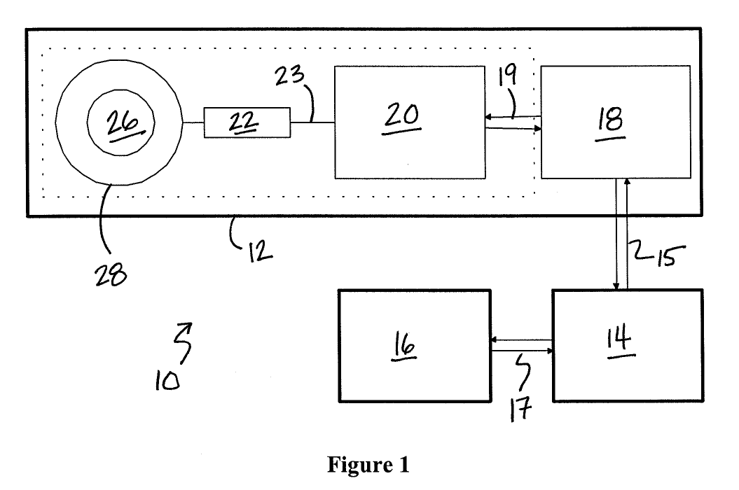

A system and method for reading and writing data wirelessly from simulated munitions 24 is illustrated in the attached FIGS. 1-6. Looking first to FIG. 1, a weapons simulation system 10 is shown having a simulated weapon 12 that is in electrical connection with a primary simulation computer 14, such as with a serial or wireless (e.g., Bluetooth) connection 15. The primary simulation computer 14 generates an electronic simulation scenario displayed on a screen or monitor to train a user in the use of the simulated weapon 12, and monitors the use of the simulated weapon 12 in the scenario. The primary simulation computer 14 is further in electrical communication with an instructor computing station 16, again such as with a serial or wireless (e.g., Bluetooth) connection 17. The instructor computing station 16 may be any computer or similar device that allows the instructor to further monitor the user's interaction and control the weapon simulation.

The simulated weapon 12 has the appearance of an actual weapon, and includes a weapon controller 18 that monitors the operation of various sensors that are used with the simulated weapon 12, such as a magazine present sensor, a trigger sensor, a safety sensor, a hammer position sensor, as well as others as conventionally used with various simulated weapons 12. The weapon controller 18 may be a conventional microcontroller or microprocessor that is able to control operation of the simulated weapon 12, and it is additionally in electrical communication with a radio-frequency identification (RFID) transceiver 20 that is housed in the simulated weapon 12. As discussed further herein, the RFID transceiver 20 is connected with an antenna 28, which will communicate with an RFID transponder tag 26 housed in the simulated munition 24 when the simulated munition 24 is used with the simulated weapon 12.

As a bit of background, RFID is an automatic identification method, relying on storing and remotely retrieving data using the RFID tags 26 or transponders. The RFID tag 26 is an object that can be applied to or incorporated into a product or item for the purpose of identification using radio waves. Some RFID tags 26 can be read from a very close proximity of the transceiver 20, while others may be meters away and beyond the line of sight of the reader, and still others may be accessible hundreds of meters away. Most RFID tags 26 contain at least two parts. The first part is an integrated circuit for storing and processing information, modulating and demodulating a radio frequency (RF) signal, and other specialized functions. The second component is an antenna for receiving and transmitting the signal to the transceiver 20.

Referring back to FIG. 1, the RFID transceiver 20 is connected with the antenna 28 via an impedance matching circuit 22. The impedance matching circuit 22 which is used to match the resistance of the transceiver 20 with the simulated munition 24 for efficient operation. The RFID transponder tag 26 as described above is placed inside of the simulated munition round 24 to store information about what type of munition is being simulated in the system 10. This intelligent simulated munitions round 24 is used in the simulated weapon 12. The RFID tag 26 also stores other data including serial numbers, usage data, service history, and other information useful for either the customer or the manufacturer. The RFID tag 26 is read by the RFID transceiver 20 that is connected with the simulated weapon 12, the transceiver 20 being added on or supported in the simulated weapon 12. The communications between the RFID tag 26 and the RFID transceiver 20 are accomplished using an antenna 28. The RFID transceiver 20 and the antenna 28 are connected through the impedance matching circuit board 22 and a coaxial cable 23. The RFID tag 26 is read by the RFID transmitter 20 when the simulated munition 24 is inserted into the simulated weapon 12 and after the simulated munition 24 has been seated into the barrel 54 or launch tube of the simulated weapon 12. After the RFID tag 26 is read, the weapon controller 18 will make decisions based on what type of simulated munitions round was read from the RFID tag 26. The data read from the RFID tag 26 is communicated to the primary simulation computer 14 and then to the instructor's computing station 16 so that instructor's computing station 16 may visually and audibly display the information to the user.

Continuing to view FIG. 1, the block diagram of the system 10 shows the data flow and processing blocks of the system 10. The instructor's computing station 16 is used to control, monitor, and update the simulation being run in real-time by a course instructor. That is, the instructor's computing station 16 will generate the graphics and scenarios being used to interact and train the user of the simulated weapon 12. During the simulation, the primary simulation computer 14 receives data and commands from both the instructor's computing station 16 and the weapon controller 18. The primary simulation computer 14 makes simulation decisions based on its programming and displays feedback to the trainee via visual means such as a projector onto a screen or using a television or monitor (not illustrated).

There are two separate processing blocks within the simulated weapon 12 which can run independent of one another. The weapon controller 18 is responsible for controlling all weapon timing of outputs, the reading of various sensors associated with the simulated weapon 12, and communication with the primary simulation computer 14. The RFID transceiver 20 executes commands to the RFID tag or transponder 26 via the antenna 28 and reads the responses from the RFID tag 26. The RFID transceiver 20 packetizes the data received from the RFID tag 26 and sends the data via a serial bus 19 or another electrical connection to the weapon controller 18. The weapon controller 18 reads the data in from the serial bus 19 and interprets the data from the RFID tag 26 as just another sensor. The weapon controller 18 will make decisions on how to fire the simulated weapon 12 based on the data from the RFID tag 26 along with other weapon sensors associated with the simulated weapon 12. The data from the RFID tag 26 gets re-packetized in a different format and sent to the primary simulation computer 14 where it is used for visual feedback to the trainee using the simulated weapon 12.

As an example, if the simulated munition 24 was designed to have a round type such as “Smoke,” then, when the simulated weapon 12 is fired, the primary simulation computer 14 will display smoke on screen corresponding to where the round was fired. However, if the round type of the simulated munition 24 is a high explosive grenade, then the primary simulation computer 14 will display an explosion on screen. Thus, various simulated munitions 24 may be incorporated into the training of the user. The data from the RFID tag 26 is also available to be viewed by the instructor on the instructor's computing station 16. It should further be noted that all of the parts of the system 10 used for RFID (seen within the dotted line in FIG. 1) are interchangeable with other simulated weapons 12. In addition, note that mechanical changes made be required to meet space constraints for various simulated weapons 12.

The RFID tags 26 used in the illustrated system 10 are passive, although it is foreseen that other types of RFID tags 26 may be implemented. That is, RFID tags are generally passive, active or semi-passive. Passive tags require no internal power source, so they are only active when a reader is nearby to power them. In contrast, semi-passive and active tags require a power source, such as a small battery. For passive RFID tags that have no internal power supply, the minute electrical current induced in the antenna by the incoming radio frequency signal provides just enough power for the integrated circuit in the tag to power up and transmit a response. Passive tags have practical read distances ranging from about four inches up to a few almost 600 feet.

In comparison to passive RFID tags, active RFID tags have their own internal power source that is used to power the integrated circuit and to broadcast the response signal to the reader. Communications from active tags to readers is typically much more reliable than communications from passive tags. Due to their on board power supply, active tags may transmit at higher power levels than passive tags, allowing them to be more robust at longer distances and in different environments. Many active tags today have operational ranges of hundreds of meters, and a battery life of up to ten years. Active tags may include larger memories than passive tags, and may include the ability to store additional information received from the reader. Although the embodiments shown herein include passive RFID tags 26, it is noteworthy that an active or semi-passive RFID tag 26 could be implemented for the user to achieve the desired results.

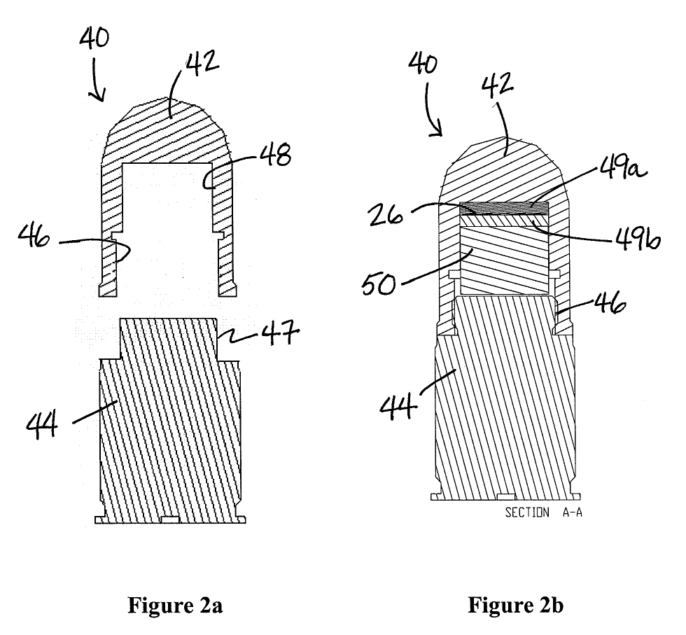

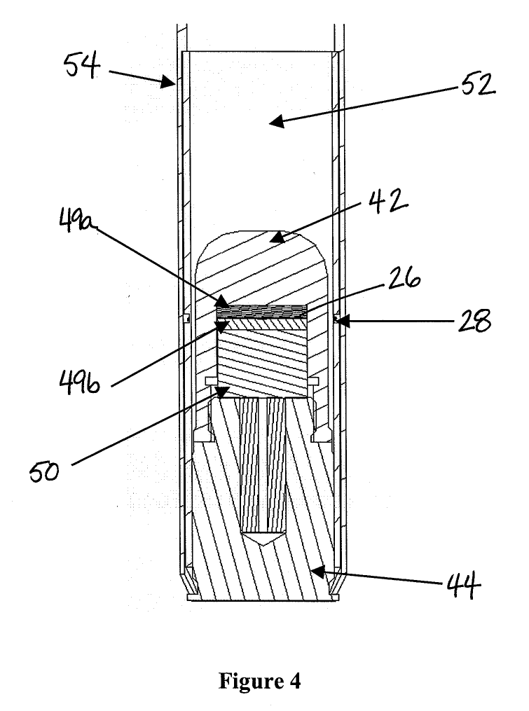

Referring to FIGS. 2-6, various embodiments of the simulated weapon 12 and simulated munition 24 are illustrated. In these embodiments, a simulated grenade launcher is able to fire a simulated munition 24 in the form of a 40 mm grenade 40. Although a grenade is illustrated, various types of munitions could be implemented. Nonetheless, the simulated grenade 40 is composed of two parts similar to an actual 40 mm grenade, namely, a simulated projectile 42 and an aluminum cartridge case 44. The simulated projectile 42 is created from a nylon rod turned down to match the profile of the live round. The inside of the projectile 42 is bored out and female threads 46 are cut into the diameter to mate with the cartridge case 44, also known as the shell. The cartridge case 44 may be made from aluminum, and has an outer diameter closely resembling that of a live round. The cartridge case 44 also has a smaller threaded diameter 47 that threads into the nylon projectile 42. Once the cartridge case 44 is threaded completely into the projectile 42, a small cavity 48 is defined for the placement of the RFID tag 26. In many cases depending on the munition being simulated, the RFID tag 26 may not completely and snugly fit into the small cavity 48. In such cases, a spacer 50, such as a nylon spacer and/or one or more foam pads 49 may be included to secure the RFID tag 26 in place and help prevent malfunction of the RFID tag 26 from unnecessary physical activity. Looking to FIGS. 2b and 4, the RFID tag 26 is supported by the foam pads 49a, 49b, with one foam pad 49b abutting the spacer 50.

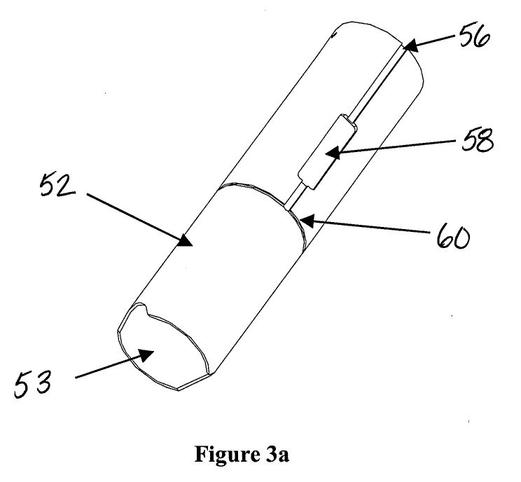

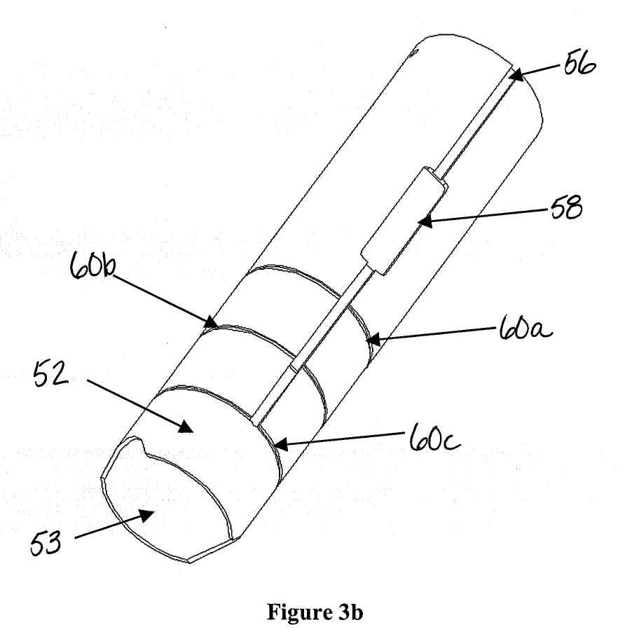

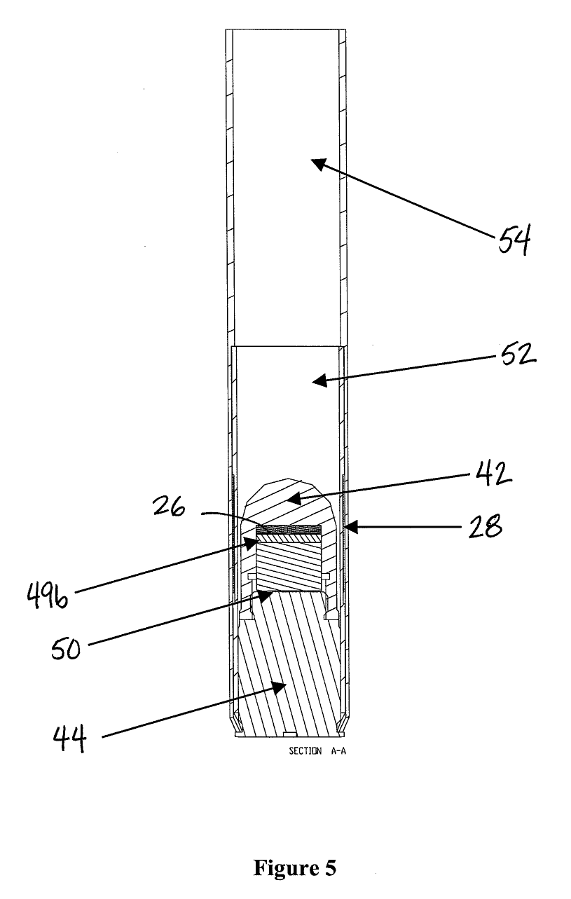

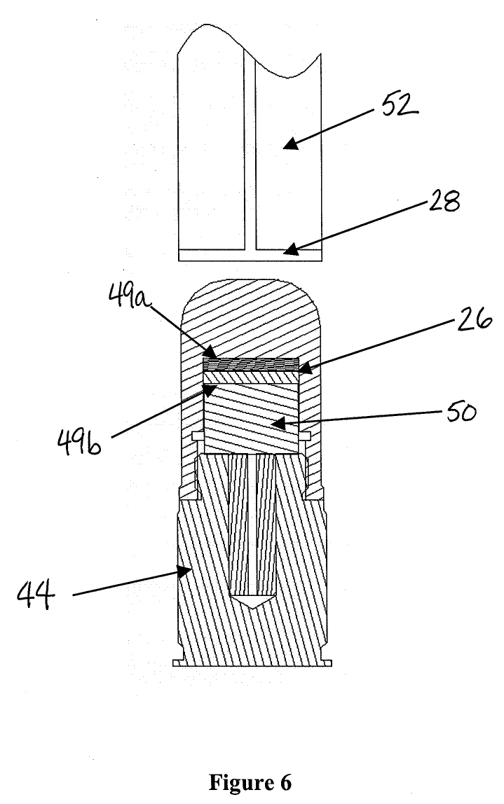

Looking to FIG. 3a, a thin walled insert 52 is designed to snugly fit into or abut an inner surface of the simulated weapon 12, such as the inner surface of the barrel 54 of the simulated weapon 12 (although the insert 52 may be positioned relative to other components of the simulated weapon 12 as appropriate to the operation of the weapon). Looking to FIG. 4, the barrel insert 52 is designed to fit into the barrel 54 of a simulated launcher or firearm, and may be affixed to the barrel 54 or launcher using any conventionally known method, such as glue, a press fit, or a screw or other connector extending through the barrel 54 and the insert 52. The barrel insert 52 has a longitudinal grove cut 56 that is used to house the coaxial cable 23 connecting the transceiver board with the antenna. A relief cut 58 in the barrel insert 52 extends along the grove cut 56, and is used to support the antenna impedance matching circuit board. Looking to FIGS. 3a and 3b, the barrel insert 52 may additionally have at least one lateral grove cut 60 at one end of the longitudinal groove cut 56 around the circumference of the barrel insert 52 to receive the coil antenna 28 for the RFID transceiver 26. In the embodiment shown in FIG. 3a and 4, the coil antenna 28 will wrap around the barrel insert 52 a limited number of times, such as three wraps around the barrel insert 52. The number of wraps of the antenna 28 around the barrel insert 52 is inversely proportional to the frequency transmission. The fewer the wraps, the higher the frequency transmission. However, it is noted that multiple wraps of the antenna 28 around the barrel insert 52 may be incorporated into the design. For example, in the embodiment shown in FIG. 3b, the barrel insert 52 has three independent lateral groove cuts 60a, 60b, and 60c that extend around the circumference of the barrel insert 52 at one end of the longitudinal groove cut 56. As a result, in this embodiment, there will be three instances in which the RFID tag 26 will communicate with the antenna 28 as the simulated munition 24 is inserted into the barrel insert 52. Further, referring to the embodiment shown in FIG. 5, the antenna 28 may have multiple wraps around the insert 52, with approximately 100 wraps of the antenna 28 being illustrated in this embodiment. Furthermore, referring to FIG. 6, another embodiment illustrates the antenna 28 be disposed at the end of the insert 52. In this embodiment, the RFID tag 26 will communicate with the KFID transceiver 20 as the simulated munition 24 is brought into range of the antenna 28.

Once the simulated munition 20 is inserted into the barrel insert 52, the RFID tag 26 will generally be positioned within the circumference of the antenna coil 28. The position of the RFID tag 26 may vary according to the materials in the barrel 54 and the particular application of the simulated munition 26, but it is desirable to have the RFID tag 26 positioned as close to the center of the circumference of the antenna 28 as possible. In the embodiment shown in FIG. 4, it is estimated that the RFID tag 26 may be positioned 0.25 inches above or below the plane of the circumference of the antenna 28. The ends of the coil antenna 28 are attached to the impedance matching circuit board 22 that fits into the relief 58 also cut into the barrel insert 52.

One end of the barrel insert 52 is a hollow recess 53 to receive the simulated 40 mm grenade round 40 inside of the barrel insert 52. The transceiver circuit board 20 that controls communication with the RFID tag 26 is located on the simulated weapon 12 where space allows. The coaxial cable 23 connects the antenna impedance matching circuit board 22 with the transceiver circuit board 20. The transceiver circuit board 20 communicates with the weapon controller card 18 via an electronic connection, such as a serial data bus, to relay munitions data.

Utilizing radio-frequency identification for simulated munitions round type detection has many advantages. For example, the RFID tag 26 can be written to or read from at any time as long as it is within range of the antenna 28 connected to the transceiver 20. This provides the advantage of allowing the same hardware to be used in all applications of simulated weapons 12 with only slight changes in the programming of the RFID tag 26. If any data on the munitions round RFID tag 26 needs to be updated, it can be done at any time from a compatible RFID transceiver 20 without requiring an electrical connection to the RFID tag 26. This includes the round type, service history, and usage data. Additionally, the RFID tag 26 may require no power (if passive, as discussed above) and is purchased as a commercial off the shelf part at a very small cost. This provides a large cost savings over custom applications throughout the life of the product. The RFID tags vary in memory capacity from 32 Bytes to more than 256 Bytes. As little as 32 Bytes would allow storage of 255 different round types and several bytes of service history and usage history. The round type could also be expanded larger however more than 255 round types may be excessive. This amount of data storage provides a very large advantage over other round type detection methods. Lastly, due to the wireless and contact-less nature of RFID, there are no mechanical connections to brake or maintain. This allows for a nearly maintenance free product with high reliability.

Although the example of munitions described above was a grenade, it is to be noted that any other munition may be used in the system 10. For example, the simulated munition 24 may take the form of a bullet, a missile, a warhead, or some other type of munition used in practicing the use of a weapon.

A first prototype RFID antenna 28 was built around a plastic tube 52 that allowed a round to be inserted into it for testing. A 40 mm near-production simulated round was used with an RFID tag 26 installed. It had a read range of approximately 2.5 inches from the coil antenna 28 along the centerline of the plastic tube. To test a version closer to production assembly, the barrel insert 52 was made out of nylon with the relief cut 58 for the impedance matching circuit board 22 and the coil antenna 28. This barrel insert 52 was placed into an aluminum tube with a 3/16 inch wall, which closely models a real barrel of a 40 mm grenade launcher. Initially, the simulated aluminum barrel 54 was offsetting the resonate frequency of the antenna 28 enough for the RFID tag 26 to be unreadable. After retuning the antenna 28, the system 10 was tested to have a read range of about three inches from the center of the coil antenna 28 along the centerline of the barrel 54.

Having thus described exemplary embodiments of a METHOD FOR READING AND WRITING DATA WIRELESSLY FROM SIMULATED MUNITIONS, it should be noted by those skilled in the art that the within disclosures are exemplary only and that various other alternatives, adaptations, and modifications may be made within the scope of the present invention. Accordingly, the invention is not limited to the specific embodiments as illustrated herein, but is only limited by the following claims.

What is claimed is:

1. A method for identifying a simulated munition inserted into a simulated weapon in a weapon simulation system having a primary simulation computer generating a training scenario for a user, said method comprising the steps of:
a. storing information about the simulated munition in a radio frequency identification tag housed in the simulated munition;
b. placing the simulated munition into an insert in the simulated weapon;
c. transmitting the information from the radio-frequency identification tag to an radio-frequency identification transceiver housed in the simulated weapon;
d. transmitting the information from the RFID transceiver to a weapon controller of the simulated weapon; and
e. transmitting the information from the weapon controller to the primary simulation computer.

2. The method as described in claim 1, wherein step b) further comprises:
positioning the simulated munition fully in the insert for the radio-frequency identification tag to substantially align with an antenna wrapped around the insert; and
transmitting information from the radio-frequency identification tag to the radio-frequency identification transceiver via the antenna.

3. The method as described in claim 1, wherein prior to step a) including the steps of:
assembling the simulated munition by attaching a simulated projectile with a cartridge case to define a cavity between the simulated projectile and the cartridge case.

4. The method as described in claim 1 further comprising the step of:
placing the radio-frequency identification tag in the cavity and at least one spacer to protect the radio-frequency identification tag.

5. A weapon simulation system comprising:
a primary simulation computer generating a simulation scenario;
a simulated weapon having a weapon controller in electrical communication with the primary simulation computer;
a radio-frequency identification transceiver connected with the simulated weapon, the transceiver in electrical communication with the weapon controller;
an insert connected with the simulated weapon;
an antenna connected to the transceiver, the antenna being supported in the simulated weapon by the insert;
a simulated munition removeably engaging the insert in the simulated weapon;
a radio-frequency identification tag housed in the simulated munition, the tag being in electrical communication with the transceiver when the simulated munition is supported in the insert.

6. The weapon simulation system as described in claim 5 wherein said simulated munition further comprises a shell having a simulated projectile and a cartridge case defining a cavity to house the radio-frequency identification tag.

7. The weapon simulation system as described in claim 6 further comprising a nylon spacer housed in the cavity.

8. The weapon simulation system as described in claim 7 further comprising first and second foam pads surrounding the radio-frequency identification tag in the cavity, the second foam pad abutting the nylon spacer.

9. The weapon simulation system as described in claim 5, wherein said insert comprises a predetermined diameter and a lengthwise axis, with a portion of the antenna wrapping around the diameter of the insert to form a plane substantially normal to the lengthwise axis.

10. The weapon simulation system as described in claim 9, wherein the radio-frequency identification tag is substantially within the plane of the antenna wrapping around the diameter of the insert when the simulated munition is supported by the insert.

11. The weapon simulation system as described in claim 5 further comprising one or more grooves extending around the insert to receive the antenna.

12. A weapon simulation system for generating a training scenario for a weapon user, said system comprising:
a primary simulation computer generating the simulation scenario;
a simulated weapon housing a weapon controller in electrical communication with the primary simulation computer, the simulated weapon having a firearm barrel;
a radio-frequency identification transceiver housed in the simulated weapon, the transceiver in electrical communication with the weapon controller;
an insert connected with the barrel of the simulated weapon;
an antenna connected to the transceiver and surrounding the insert, the antenna being supported in the simulated weapon by the insert;
a simulated munition removeably engaging the insert in the simulated weapon;
a radio-frequency identification tag housed in the simulated munition and in electrical communication with the transceiver when the simulated munition is supported in the insert.

13. The weapon simulation system as described in claim 12 wherein said simulated munition further comprises a shell having a simulated projectile and a cartridge case defining a cavity to house the radio-frequency identification tag.

14. The weapon simulation system as described in claim 13 further comprising at least one spacer housed in the cavity.

15. The weapon simulation system as described in claim 14 further comprising first and second foam pads surrounding the radio-frequency identification tag in the cavity, the second foam pad abutting the spacer.

16. The weapon simulation system as described in claim 12, wherein said insert comprises a predetermined diameter and a lengthwise axis, with a portion of the antenna wrapped around the diameter of the insert to form a plane substantially normal to the lengthwise axis.

17. The weapon simulation system as described in claim 16, wherein the radio-frequency identification tag is substantially within the plane of the antenna wrapping around the diameter of the insert when the simulated munition is supported by the insert.

18. The weapon simulation system as described in claim 12, wherein the insert includes a first edge and a second edge, the antenna extending around the first edge of the insert.
